(19) United States
(12) Patent Application Publication
(10) Pub. No.: US 2025/0208713 A1
(43) Pub. Date: Jun. 26, 2025

(54) Control Device, Control Method, Haptic Feedback System, and Program for Haptic Feedback Control

(71) Applicant: Kurimoto, Ltd., Osaka-shi, Osaka (JP)

(72) Inventors: Shuichi Akaiwa, Osaka-shi, Osaka (JP); Keisuke Kinoi, Osaka-shi, Osaka (JP)

(21) Appl. No.: 18/850,852

(22) PCT Filed: Mar. 10, 2023
(86) PCT No.: PCT/JP2023/009318

§ 371 Date: Sep. 25, 2024

(30) Foreign Application Priority Data
Mar. 30, 2022 (JP) 2022-057117

(51) Int. Cl. G06F 3/01; G06F 3/0487

(52) U.S. Cl. CPC G06F 3/016; G06F 3/0487

(57) ABSTRACT

Provided are a control device, a control method, a haptic feedback system, and a program product for improving perceptibility of haptic sensation by a haptic feedback device. This control device is for a haptic feedback device having a movable part and inducting a sense of force for operation on the movable part in accordance with the movement amount of the movable part and presenting a haptic of an object to be displayed. The control device: stores, for each object to be displayed, control data for generating the sense of force in a case where the object is displayed in association with the movement amount of the movable part; corrects the correspondence relationship between the movement amount and the control data so as to change a scale of the range of the movement amount to the range of the control data; and output, to the haptic feedback device, corrected control data.

### CROSS-REFERENCE TO RELATED APPLICATIONS

This application is the national phase under 35 U. S. C. § 371 of PCT International Application No. PCT/JP2023/009318 which has an International filing date of Mar. 10, 2023 and designated the United States of America.

### FIELD

The present invention relates to a control device a control method, a haptic feedback system, and a program product which improve perceptibility of haptic sensation presented by a haptic feedback device.

### BACKGROUND ART

A technology of transmitting an image and a sound related to visual sensation and auditory sensation among five human senses has become highly accurate, and recently, various technologies of presenting haptic sensation (haptics) have been proposed.

As a technology of presenting haptic sensation, it has been proposed to reproduce vibration when an image of an object displayed on a display with a built-in touch panel is touched, mainly three kinds of vibration (eccentric rotating mass (ERM), linear resonant actuator (LRA), and a piezo element). However, in the haptic presentation on the touch panel, it is difficult to reproduce haptic sensation at a deeper portion, that is, a sense of force generated not only by a skin of a finger but also by a muscle or a tendon.

The present inventors have proposed a haptic feedback device that can be operated by an operator and reproduces a different haptic sensation depending on an object on the basis of the finding for a magneto-rheological fluid.

### SUMMARY

A haptic feedback device includes a movable part such as a curved plate that can be moved with respect to a base portion by an operator's operation. In a state in which the haptic feedback device is not controlled, the movable part can be moved by the operator without resistance, but when being controlled, the haptic feedback device presents haptic sensation by changing the magnitude of a sense of force generated in the movable part in correspondence with a movement amount (position) of the movable part, a method of outputting the sense of force, and the like.

A way of movement of the movable part of the haptic feedback device is different depending on a difference in a size of a hand, a difference in a muscle, and the like of the operator.

In addition, depending on the operator, in a case of performing an operation to move the movable part, the ease of perception as haptic sensation is difference depending on timing at which the sense of force in the movable part is output. Here, it is desirable to be able to set the haptic feedback device so that each operator can easily perceive the haptic sensation.

The invention has been made in consideration of such circumstances, and an object thereof is to provide a control device, a control method, a haptic feedback system, and a program product which improve perceptibility of haptic sensation presented by a haptic feedback device.

A control device of an embodiment of the present disclosure is a control device of a haptic feedback device that includes a movable part provided to be moved in response to an operation by an operator, generates a sense of force for the operation on the movable part in correspondence with a movement amount of the movable part, and presents haptic sensation of a displayed object. The control device stores control data for generating the sense of force in association with the movement amount of the movable part for every object, corrects a correspondence relationship between the movement amount of the control data and the control data on the basis of setting so as to change a scale of a range of the movement amount of the movable part with respect to a range of the control data, and outputs the corrected control data associated with the movement amount of the movable part to the haptic feedback device.

A control method of the embodiment of the present disclosure is a control method of a haptic feedback device that includes a movable part provided to be movable in response to an operation by an operator, generates a sense of force for the operation on the movable part in correspondence with a movement amount of the movable part, and presents haptic sensation of a displayed object. In the method, a computer connected to the haptic feedback device, stores control data for generating the sense of force in association with the movement amount of the movable part for every object, corrects a correspondence relationship between the movement amount of the control data and the control data on the basis of the setting so as to change a scale of a range of the movement amount of the movable part with respect to a range of the control data, and outputs the corrected control data associated with the movement amount of the movable part to the haptic feedback device.

A program product of the embodiment of the present disclosure causes a computer, which is connected to a haptic feedback device that includes a movable part provided to be moved in response to an operation by an operator, generates a sense of force for the operation on the movable part in correspondence with a movement amount of the movable part, and presents haptic sensation of a displayed object, to execute processing of: storing control data for generating the sense of force in association with the movement amount of the movable part for every object; correcting a correspondence relationship between the movement amount of the control data and the control data on the basis of the setting so as to change a scale of a range of the movement amount of the movable part with respect to a range of the control data; and outputting the corrected control data associated with the movement amount of the movable part to the haptic feedback device.

In the control device, the control method, and the program product of the present disclosure, the correspondence relationship between the movement amount and the control data is stored in advance, and the scale is changed so that haptic presentation is made within a movable range of the movable part of the haptic feedback device when the haptic feedback device is used.

The control device of the embodiment of the present disclosure accepts a movement amount at which the control data starts to be output to the movable part as the setting, and changes the scale on the basis of the accepted movement amount and a movable range of the movable part.

In the control device of the present disclosure, when the movement amount (a haptic presentation initiation position), at which haptic sensation starts to be presented by the movable part by operator's selection or control by the control device, is set, the scale is changed so that the haptic sensation can be presented within the movable range from the haptic presentation initiation position.

The control device of the embodiment of the present disclosure accepts the change of the scale.

In the control device of the present disclosure, the change of the scale can be accepted from an outer side. The operator can change the scale as desired.

In the control device of the embodiment of the present disclosure, the control data is stored in association with the movement amount on the basis of an actual size of the movable range of the movable part and an actual size of the object, and the correspondence relationship between the movement amount of the movable part and the control data is corrected on the basis of the changed scale.

In the control device of the present disclosure, the control data that is stored in advance is set so that the sense of force is presented to the movable part in order for the actual value of the movable range of the movable part and the size of the object to correspond to each other. Setting for the scale at which the object is output is accepted, and the range in which the sense of force is output to the movable part can be changed in accordance with the set scale.

A haptic feedback system of the embodiment of the present disclosure comprises: a haptic feedback device that includes a movable part provided to be movable in response to an operation by an operator, generates a sense of force for the operation on the movable part in correspondence with a movement amount of the movable part, and presents haptic sensation of a displayed object; and an information processing device that is communicatively connected to the haptic feedback device and includes a display unit. The information processing device stores control data for generating the sense of force in association with the movement amount of the movable part, and visual data that is displayed on the display unit for every object, corrects a correspondence relationship between the movement amount of the control data and the control data on the basis of setting so as to change a scale of a range of the movement amount of the movable part with respect to a range of the control data, outputs the corrected control data associated with the movement amount of the movable part to the haptic feedback device, and outputs an image to the display unit in correspondence with the movement amount of the movable part on the basis of the visual data after correction.

In the haptic feedback system of the present disclosure, the correspondence relationship between the movement amount and the control data is stored in advance, the scale is changed so that haptic presentation is made within a movable range of the movable part of the haptic feedback device when the haptic feedback device is used, and an image is displayed by the information processing device in correspondence with the change.

According to the present disclosure, a haptic presentation range by a haptic feedback device can be adjusted in correspondence with an operator, and perceptibility of haptic sensation can be improved.

The above and further objects and features will more fully be apparent from the following detailed description with accompanying drawings.

### BRIEF DESCRIPTION OF DRAWINGS

FIG. 1 is a schematic view illustrating a haptic feedback system.

FIG. 2 is a block diagram illustrating a configuration of an information processing device.

FIG. 3 is a view illustrating a content example of a sensation DB.

FIG. 4 is a block diagram illustrating a configuration of a haptic feedback device.

FIG. 5 is a flowchart illustrating an example of a basic procedure of haptic presentation in the haptic feedback system.

FIG. 6 is a schematic diagram illustrating an example of haptic presentation in the haptic feedback system.

FIG. 7 is a flowchart illustrating an example of a setting method.

FIG. 8 illustrates an example of a setting screen displayed on a display unit.

FIG. 9 is a flowchart illustrating an example of a correction procedure according to a presentation initiation position.

FIG. 10 is a view illustrating a correction method.

FIG. 11 is a view illustrating a correction method.

FIG. 12 is a view illustrating a correction method.

FIG. 13 illustrates another example of the setting screen displayed on the display unit.

FIG. 14 is a schematic view illustrating an example of haptic presentation in the haptic feedback system.

FIG. 15 is a flowchart illustrating an example of a setting method according to a second embodiment.

FIG. 16 is a flowchart illustrating an example of a correction procedure according to a scale.

FIG. 17 is a view illustrating a correction method according to the second embodiment,

FIG. 18 is a schematic view of a haptic feedback system according to a third embodiment.

FIG. 19 is a block diagram illustrating a configuration of an HMD.

### DESCRIPTION

The present disclosure will be described in detail with reference to the drawings illustrating embodiments thereof. In the following embodiments, an implementation of a setting method in a haptic feedback system will be described.

### First Embodiment

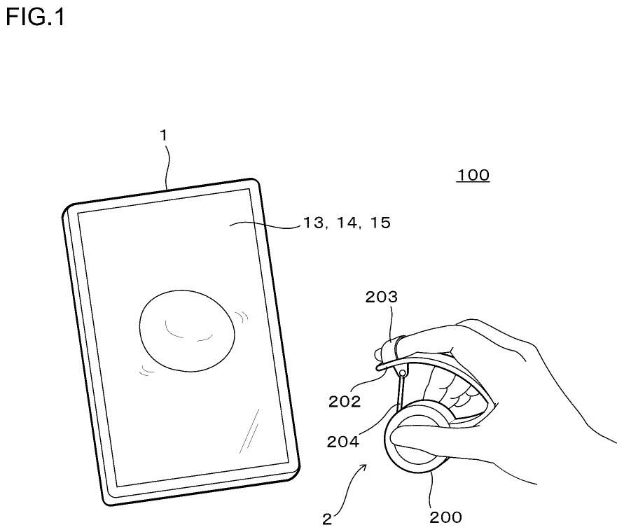

FIG. 1 is a schematic view illustrating a haptic feedback system 100. The haptic feedback system 100 includes an information processing device 1 and a haptic feedback device 2. The information processing device 1 and the haptic feedback device 2 are communicatively connected via short-range wireless communication and transmit and receive data therebetween.

As illustrated in FIG. 1, as the information processing device 1, a smartphone is used. The information processing device 1 may be a tablet terminal or a laptop type personal computer (PC) instead of the smartphone.

The haptic feedback device 2 is a device that can be operated by an operator by moving a finger while holding the finger along a movable part 202. The haptic feedback device 2 is a device that reads a position of the movable part 202 that is displaced when the operator moves the finger, controls a built-in magneto-rheological fluid (MRF) device 24 in correspondence with a position thereof to generate a sense of force by a reaction force (rotational resistance) against the operation by the operator on the movable part 202, thereby presenting haptic sensation. An aspect of the movable part 202 of the haptic feedback device 2 is not limited to the aspect illustrated in FIG. 1, and may be a stick-like shape or a cushion-like shape covered with a cover. The haptic feedback device 2 may employ a motor, a piezo element, or the like instead of the MRF device 24 to generate the sense of force by a rotational force or vibration in response to the operation of the operator, or may be combined with a device that presents vibration, hot sensation, and cold sensation other than the movable part 202. A structure that is installed on the ground or a wall and is operated by an operator's palm, foot, or the like.

In the haptic feedback system 100, the haptic feedback device 2 cooperates with the information processing device 1, and outputs haptic sensation of an object to the haptic feedback device 2 while outputting an image and a sound of the object by using the information processing device 1, another display device, a speaker, or the like. In the example illustrated in FIG. 1, a soft object is displayed on a display unit 13 of the information processing device 1, and when the operator pushes the movable part 202 of the haptic feedback device 2 with a finger, the haptic feedback device 2 displays an image in which an object changes as if being pushed on the display unit 13 while outputting squishy or fluffy haptic sensation, and outputs a sound that sounds like “squishy” corresponding to the pushing of the object from the voice output unit 14.

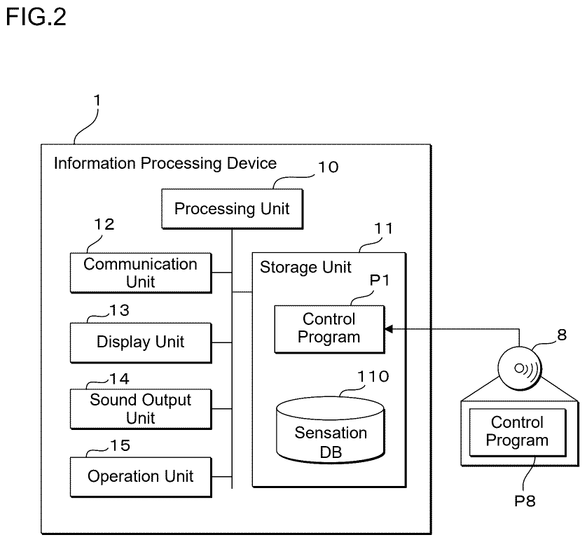

FIG. 2 is a block diagram illustrating a configuration of the information processing device 1. The information processing device 1 includes a processing unit 10, a storage unit 11, a communication unit 12, a display unit 13, a sound output unit 14, and an operation unit 15. The processing unit 10 is a processor that uses a central processing unit (CPU), and/or a graphics processing unit (GPU). The processing unit 10 executes the following processing on the basis of a control program P1 for haptic presentation stored in the storage unit 11.

The storage unit 11 uses a non-volatile memory such as a flash memory or a solid state drive (SSD). The storage unit 11 stores data that is referred to by the processing unit 10. The control program P1 (program product) is downloaded from the information processing device 1 for another program server device via the communication unit 12, and is stored in an executable manner. The control program P1 stored in the storage unit 11 may be a control program P8 that is stored in a computer-readable storage medium 8 and is read out by the processing unit 10.

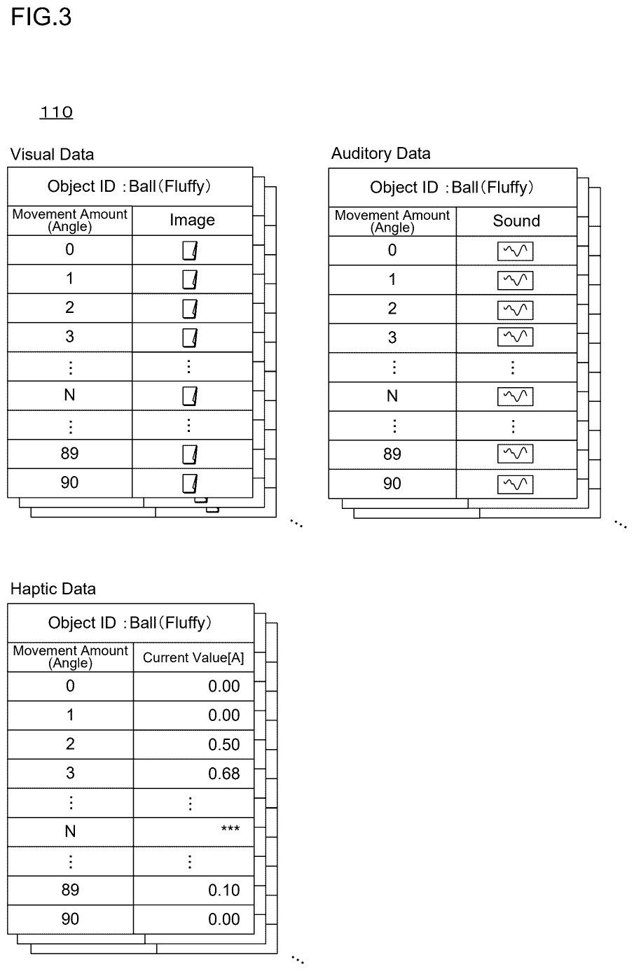

The storage unit 11 stores a sensation database (DB) 110 including haptic data, visual data, and auditory data of an object to be output. The sensation DB 110 stores, for every movement data of a movable part in the haptic feedback device 2, haptic data, visual data (an image, and a moving image), and auditory data (voice) to be output for the movement amount in association with an object ID for identifying an object (refer to FIG. 3). The storage unit 11 further stores setting data for each operator.

The communication unit 12 is a communication module of short-range wireless communication, for example, Bluetooth (registered trademark). The processing unit 10 can transmit and receive data to and from the haptic feedback device 2 by the communication unit 12.

The display unit 13 is a display such as a liquid crystal monitor, and an organic electro luminescence (EL) display. For example, the display unit 13 is a display with a built-in touch panel. The processing unit 10 displays an operation screen for outputting haptic sensation with the haptic feedback device 2 or an image of an object on the display unit 13 on the basis of the control program P1.

The voice output unit 14 includes a speaker and the like. The processing unit 10 outputs a voice, music, and the like of the object from the voice output unit 14 on the basis of the control program P1.

The operation unit 15 is a user interface capable of inputting and outputting data to and from the processing unit 10, and is a touch panel with the built-in display unit 13. The operation unit 15 may be a physical button. The operation unit 15 may be a voice input unit.

FIG. 3 is a view illustrating a content example of the sensation DB 110. As illustrated in FIG. 3, the sensation DB 110 stores a current value of a current to an MRF device of the haptic feedback device 2 for every movement amount (angle) of the movable part 202 as the haptic data in association with the object ID. A voltage value or the like may be stored without limitation to the current value. A plurality of the objects may exist, and may include real objects as objects that present haptic sensation, for example, still objects such as balls or balloons, foods such as gummies, vegetables, or fruits, animals such as dogs, cats, or fishes, or may include characters such as slimes or monsters.

A relationship between the movement amount of the movable part 202 in the sensation DB 110 and the current value is set in accordance with an actual size of a movable range of the movable part 202 and a size of the object. For example, in a case where the movable range of the movable part 202 is 50 mm, the object is a non-bursting spherical body such as a small gummy, and the size thereof is set to 15 mm, the current value is set so that the haptic sensation is reproduced in a range of approximately the first 15 mm, and rotational resistance that makes it feel as if it cannot be pushed any further is generated for the remaining range of 35 mm. Alternatively, a large current value with which pushing is no longer possible may be set for a range of 12 mm to 15 mm, and a current value thereafter may be set to zero. In addition, in a case where the object is a large object such as a sofa seat and a size thereof greatly exceed the movable range of the movable part 202, in the haptic data, a current value is set to present haptic sensation up to 50 mm from a surface of the sofa seat. In a case where the object is a virtual character such as a monster, the current value is set on the basis of a size corresponding to setting of the character.

Similarly, the sensation DB 110 stores an image (frame image) for every movement amount (angle) of the movable part 202 as visual data in association with the object ID. Here, the frame image is one still image that is recognized as an animation image when being displayed continuously. In addition, similarly, a voice for every movement amount (angle) of the movable part 202 is stored as auditory data in association with the object ID. The auditory data may be waveform data that is different for each angle. The auditory data may be timestamp of a sound corresponding to each angle.

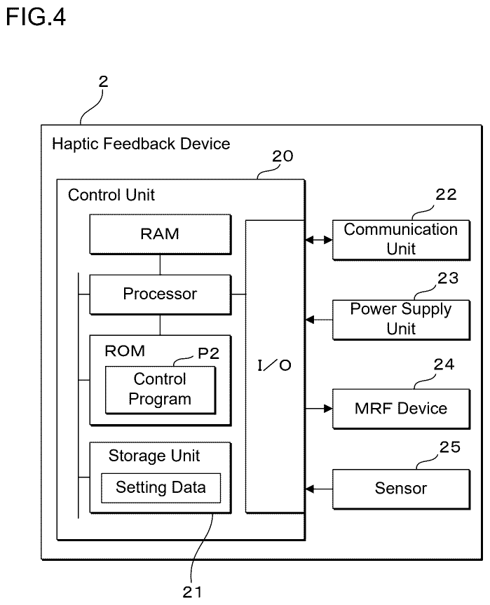

FIG. 4 is a block diagram illustrating a configuration of the haptic feedback device 2. As illustrated in FIG. 1, the haptic feedback device 2 includes a flat bottomed cylindrical grip body 200, and the belt-like flat plate-shaped movable part 202 including a curved portion that partially conforms to the grip body 200 in a peripheral direction. The movable part 202 is formed from a flexible material, but a high-rigidity material may be employed and may be rotatably supported to the grip body 200 through a support shaft. A cloth tape-shaped binder 203 is provided on an outer surface of the tip end of the movable part 202. A link mechanism 204 that is connected to a rotation shaft of a rotor of the MRF device 24 accommodated inside the grip body 200 is provided on an inner surface of the tip end of the movable part 202.

As illustrated in FIG. 1, an operator inserts the index finger into the binder 203 in use in a state in which a finger such as the index finger is conforming to the movable part 202 while gripping the grip body 200, for example, with the thumb and the middle finger. The operator can move the movable part 202 by pushing the movable part 202 with the index finger, and can move the movable part 202 away from the grip body 200 by extending the index finger.

As illustrated in FIG. 1, the haptic feedback device 2 includes the grip body 200, a control unit 20, a storage unit 21, a communication unit 22, a power supply unit 23, the MRF device 24, and a sensor 25. The grip body 200 includes the built-in MRF device 24. The control unit 20, the storage unit 21, the communication unit 22, and the power supply unit 23 may be provided integrally with the grip body 200, or may be provided separately and connected to the grip body 200 in a wireless manner or a wired manner.

The control unit 20 includes a CPU, a processor such as a micro-processing unit (MPU), and a memory such as a read only memory (ROM) and a random access memory (RAM). For example, the control unit 20 is a microcontroller. The control unit 20 controls respective constituent units on the basis of the control program P2 stored in the built-in ROM, and realizes haptic presentation.

The storage unit 21 is an auxiliary storage memory for the control unit 20 and stores control data (haptic data) of the MRF device 24 in a rewritable manner.

The communication unit 22 is a communication module of a short-range wireless communication, for example, Bluetooth (registered trademark). The control unit 20 transmits and receives data to and from the information processing device 1 by the communication unit 22, and stores the data.

The control unit 20 is connected to the power supply unit 23, the MRF device 24, and the sensor 25 via an I/O, and transmits and receives signals therebetween.

The power supply unit 23 includes a chargeable battery. The power supply unit 23 supplies power to the respective constituent units and the MRF device 24 when being turned on.

The MRF device 24 includes a yoke that is provided to sandwich a disk-shaped rotor with a gap therebetween, generates a magnetic field by causing a control current to flow through a coil provided in the yoke, and controls viscosity (shearing stress) of a magneto-rheological fluid sealed in the gap to apply rotational resistance of the rotor. When the control unit 20 controls the magnitude of the control current to the MRF device 24, the rotational resistance is instantly changed.

The sensor 25 measures a movement amount (angle) of the movable part 202 and outputs the movement amount to the control unit 20. The sensor 25 measures a movement of the movable part 202 as an angle and outputs the movement. The sensor 25 may be configured by a plurality of sensors such as a gyro sensor and an acceleration sensor.

In the haptic feedback device 2 configured as described above, when the movable part 202 is operated by an operator, the movement of the movable part 202 is transmitted in a rotational direction to a rotational axis of the rotor of the MRF device 24 through the link mechanism 204. In a case where the MRF device 24 does not operate, that is, while the control current is zero, the rotational axis freely rotates, and thus the movable part 202 fluctuates without resistance. On the other hand, in a case where the MRF device 24 operates and the control current is not zero, the viscosity (shearing stress) of the magneto-rheological fluid inside the MRF device 24 is changed depending on the magnitude of the current flowing through the MRF device 24. The control unit 20 can change a force of resistance against the movable part 202 and a way of appearance thereof by continuously changing the magnitude of the current to the MRF device 24 or by oscillating a current value at a predetermined frequency.

In this way, the haptic feedback device 2 can present slimy haptic sensation by fluctuating resistance (current value) in correspondence with a pushed amount (movement amount) of the movable part 202, can present firm and hard haptic sensation by increasing resistance in correspondence with an increase of the pushed amount, or can present crunchy haptic sensation by alternating large resistance and small resistance.

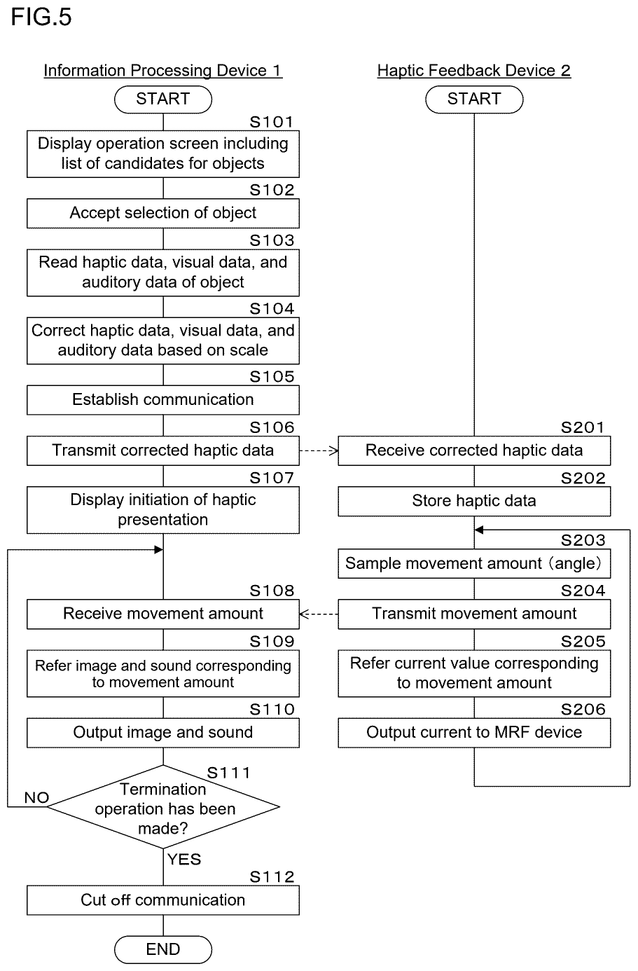

FIG. 5 is a flowchart illustrating an example of a basic procedure of haptic presentation in the haptic feedback system 100. When an operator activates the control program P1 and turns on the power of the haptic feedback device 2, the processing unit 10 of the information processing device 1 initiates the following processing in cooperation with the haptic feedback device 2.

The processing unit 10 displays an operation screen including a list of candidates for objects for which haptic sensation is to be displayed on the display unit (step S101), and accepts selection of an object (step S102). The processing unit 10 reads haptic data, visual data, and auditory data corresponding to an object ID of the selected object from the sensation DB 110 of the storage unit 11 (step S103).

The processing unit 10 corrects the read haptic data, image data, and sound data on the basis of a scale that is set in the following processing, and temporarily stores the corrected data (step S104). Details of a correction method in step S104 will be described later.

The processing unit 10 establishes communication with the haptic feedback device 2 by the communication unit 12 (step S105), and transmits the temporarily stored corrected haptic data to the haptic feedback device 2 (step S106). The processing unit 10 displays initiation of haptic presentation on the display unit 13 (step S107).

When receiving the haptic data (step S201), the control unit 20 of the haptic feedback device 2 stores the haptic data in the storage unit 21 (step S202).

The control unit 20 samples a signal corresponding to a movement amount (angle) of the movable part 202 which is output from the sensor 25 (step S203). The control unit 20 transmits the movement amount obtained by the sampling to the information processing device 1 (step S204), refers to a current value corresponding to the obtained movement amount from the haptic data stored in the storage unit 21 (step S205), outputs the referred-to current to the MRF device 24 (step S206), and returns the processing to step S203. The processing from step S203 to step S206 is continued until a termination operation is made on the information processing device 1 side.

The information processing device 1 receives the movement amount from the haptic feedback device 2 (step S108), and the processing unit 10 refers to an image and a sound corresponding to the received movement amount from the visual data and the auditory data in the storage unit 11 (step S109). The processing unit 10 outputs the visual data and the auditory data from the display unit 13 and the sound output unit 14 (step S110), and returns the processing to step S108. Whenever a movement amount is transmitted from the haptic feedback device 2, the information processing device 1 outputs an image and a sound corresponding to the movement amount.

The processing unit 10 determines whether or not the termination operation has been made (step S111). In a case where it is determined that the termination operation is not made (S111: NO), the processing is returned to step S108, and the processing in step S108 to step S110 is repeated.

In a case where it is determined that the termination operation has been made (S111: YES), the processing unit 10 terminates displaying and cuts off communication with the haptic feedback device 2 (step S112), and terminates the processing.

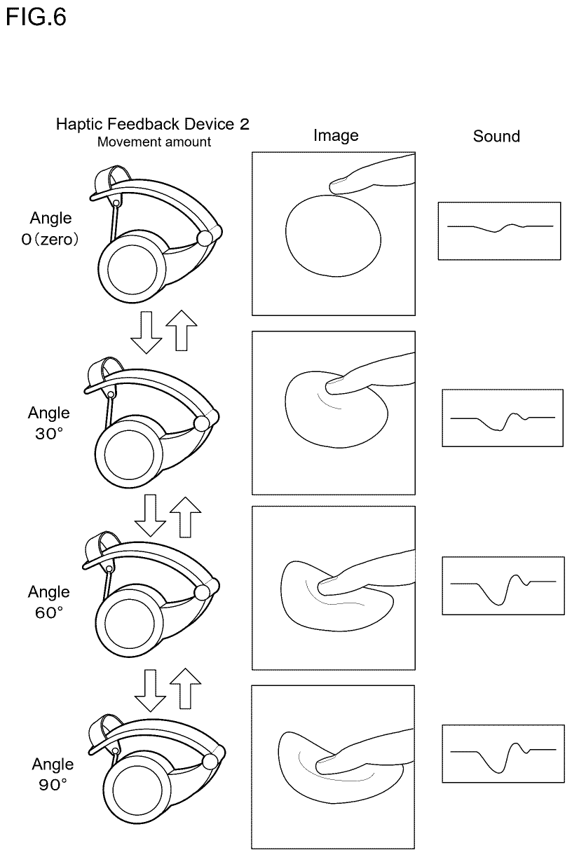

FIG. 6 is a schematic diagram illustrating an example of haptic presentation in the haptic feedback system 100. FIG. 6 shows a variation of an image displayed on the display unit 13 and a variation of a sound in correspondence with the movement amount in the haptic data transmitted to the haptic feedback device 2. As illustrated in FIG. 6, the image varies and depression corresponding to the haptic sensation varies in correspondence with the pushed amount of the movable part 202. In addition, as illustrated in FIG. 6, in a case where an image of an operator's finger is displayed in an image, the image of the finger that comes into contact with the object in the image may be displayed from a location of contact, that is, an initial position (where movement amount is zero) that is output to the MRF device 24.

Here, a relationship between the movement amount and the control data is set in accordance with an actual size of the movable range of the movable part 202 and an actual size of the object. That is, the crushed thickness (variation amount) of a crushed object shown in FIG. 6 is set to match an actual size of the movement amount of the movable part 202 of the haptic feedback device 2. In contrast, with the following setting, the information processing device 1 can change a scale of the correspondence between the variation amount of the object and the movement amount of the movable part 202 without limitation to the actual size.

In the haptic feedback system 100 that presents haptic sensation as described above, during haptic presentation processing described above, in step S104 of the procedure shown in the flowchart of FIG. 5, when the information processing device 1 corrects the haptic data, an output to the haptic feedback device 2 can be adjusted to each individual operator.

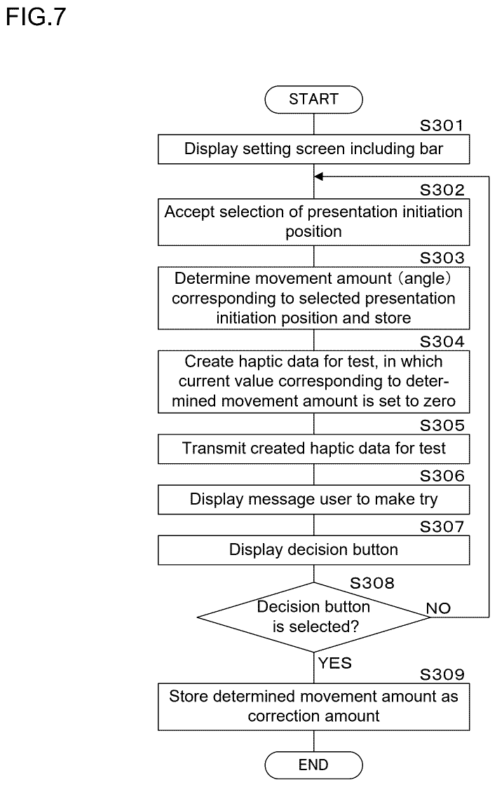

FIG. 7 is a flowchart illustrating an example of a setting method. The following procedure is initiated in a case where a setting menu is selected on an operation screen displayed on the basis of the control program P1. The procedure shown in FIG. 7 may be automatically initiated when processing based on the control program P1 is executed for the first time. Initially, a movement amount corresponding to a presentation initiation position is zero.

The processing unit 10 displays a setting screen including a bar corresponding to an angle range of the movement amount (step S301). The processing unit 10 accepts selection of the presentation initiation position by the bar (step S302), determines a movement amount (angle) corresponding to the selected presentation initiation position, and stores the movement amount (step S303). In step S303, the processing unit 10 determines a position of a movement amount in a range (0 to 90° (degrees)) of the movement amount from a ratio of a length of a selected position to a length of the bar, and stores the position. That is, when the length of the bar is set to 100, in a case where a length up to a selected position is 10, since the ratio is 10%, 9° (degrees) is determined as a movement amount corresponding to the presentation initiation position.

The processing unit 10 sets a current value to the movement amount (angle) corresponding to the presentation initiation position to zero, and creates haptic data in which a predetermined current value is set to a movement amount equal to or greater than the movement amount corresponding to the presentation initiation position (step S304). The processing unit 10 transmits the created haptic data to the haptic feedback device 2 (step S305), and displays a message prompting a user to make a try on the setting screen on the display unit 13 (step S306).

The control unit 20 of the haptic feedback device 2 causes a current corresponding to the movement amount of the moveable part to flow through the MRF device 24 on the basis of the received haptic data, and enables a test, in which a predetermined reaction force (rotational resistance) is generated for the first time when the moveable part 202 is further pushed as compared to the movement amount corresponding to the presentation initiation position that is set, to be executed. According to this, the operator is allowed to test a delay (play and shift) before starting to feel the reaction force.

The processing unit 10 displays a decision button on the setting screen (step S307), and accepts whether or not the presentation initiation position selected in step S302 is acceptable as a result of the test. The processing unit 10 determines whether or not the decision button is selected (step S308). In a case where the decision button is not selected (S308: NO), the processing unit 10 returns the processing to step S302 and repeats the processing until the decision button is selected.

In a case where it is determined that the decision button is selected (S308: YES), the processing unit 10 stores the movement amount (angle) determined in step S303 as a correction amount in the storage unit 11 (step S309), and terminates the processing.

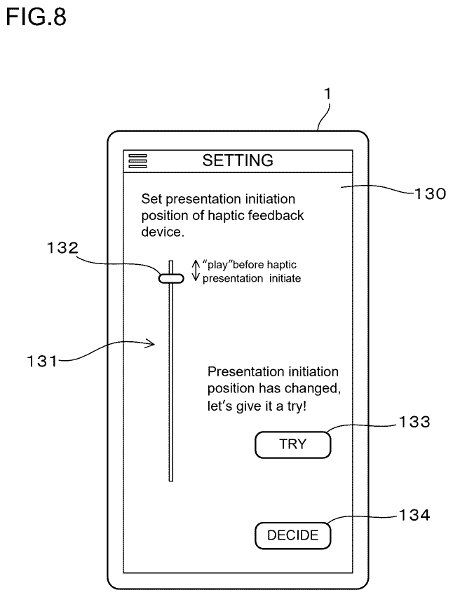

FIG. 8 shows an example of a setting screen 130 that is displayed on the display unit 13. In a case where the setting menu is selected by the operation unit 15, the processing unit 10 displays the setting screen 130 on the display unit 13. A bar interface 131 including a control 132 that is slidable with respect to a length corresponding to a range of a movement amount is included in the setting screen 130. An operator can vertically move the control 132 on a touch panel with the built-in display unit 13.

The setting screen 130 includes a test button 133 and a decision button 134. When the test button 133 is selected by the operator, the processing unit 10 detects the selection by the operation unit 15, and determines a movement amount in step S303 by a position of the moved control 132. In a case where the test button 133 is selected, the processing unit 10 executes processing in step S304 to step S308.

In a case where the decision button 134 is selected, the processing unit 10 executes step S308 to step S309.

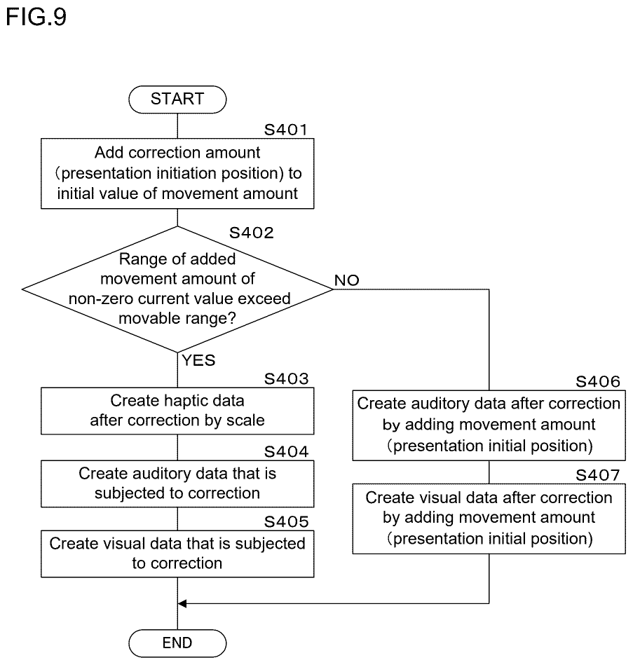

According to this, the correction amount of the presentation initiation position in a case of operating the movable part 202 is set for every operator, and is reflected on step S104 in the processing shown in the flowchart of FIG. 5. FIG. 9 is a flowchart illustrating an example of a correction procedure by the presentation initiation position.

The processing unit 10 adds the amount (angle) stored as a correction amount to an initial value of the movement amount (angle) of the haptic data that is read in step S104 (step S401). In a case where the amount (angle) stored as the correction amount is added to the movement amount of the haptic data, the processing unit 10 determines whether or not the movement amount corresponding to a non-zero current value exceeds the movable range of the movable part 202 (step S402).

In a case where it is determined that the movement amount exceeds the movable range (S402: YES), the processing unit 10 creates haptic data after correction by changing a scale so that the movement amount corresponding to the non-zero current value falls within the movable range of the movable part 202 (step S403). Details of each creation method will be described later.

In step S403, for example, the processing unit 10 calculates a coefficient obtained by using the sum of a value corresponding to the presentation initiation position stored as the correction amount and the maximum value of the movement amount as a denominator, and a movable range (for example, 90 of 0 to 90° (degrees)) of the movable part 202 as a numerator. The processing unit 10 may allocate a value obtained by multiplying the sum of each movement amount in the haptic data and an amount (angle) stored as the correction amount by the coefficient ([Method 1]).

In step S403, the processing unit 10 also calculates a coefficient obtained by using the sum of the value corresponding to the presentation initiation position stored as the correction amount and the maximum of the movement amount corresponding to a non-zero current value as a denominator, and the movable range (for example, 90 of 0 to 90° (degrees)) of the moveable part 202 as a numerator. The processing unit 10 may allocate a value obtained by multiplying the sum of each movement amount in the haptic data and an amount (angle) stored as the correction amount by the coefficient ([Method 2]).

In step S403, the processing unit 10 may allocate a value obtained by multiplying an increment, which is obtained by dividing a difference between the maximum value of the movement amount and a value corresponding to the presentation initiation position stored as a correction amount by the unit number (for example, 91 corresponding to 0 to 90° (degrees)) of movement amounts, by the number of the movement amounts, and by adding the resultant value to the initial value ([Method 3]). In addition, in the case of the method ([Method 3]), the determination on whether or not to exceed the movable range in step S402 is not necessary.

With respect to each movement amount of the auditory data that is read, the processing unit 10 creates auditory data that is subjected to correction by a similar method as in step S403 (step S404).

With respect to each movement amount of the visual data that is read, the processing unit 10 creates corrected visual data that is subjected to correction by a similar method as in step S403 (step S405), and terminates the correction.

In step S405, in a case of virtually superimposing the image of the operator's finger on the image that is visual data, the processing unit 10 may calculate coordinates for displaying the image of the finger so that the image of the finger appears to be in contact with the object at timing when the same movement amount as the movement amount stored as the correction amount is transmitted from the haptic feedback device 2. In this case, the processing unit 10 may adjust the image so that timing at which the haptic sensation occurs and timing at which the image of the finger appears to be in contact with the object in the image match each other on the basis of the presentation initiation position and a movement amount (angle) at which the current value is not zero in the haptic data.

In step S402, in a case where it is determined that it does not exceed the movable range (S402: NO), the processing unit 10 creates haptic data after correction by adding the movement amount stored as the correction amount to each movement amount of the haptic data that is read (step S406). According to this, it is possible to shift the movement amount at which a continuously changing current value in the haptic data starts to be output.

Similarly, the processing unit 10 creates auditory data after correction by adding the movement amount stored as the correction amount to each movement amount of the auditory data that is read (step S407).

The processing unit 10 creates visual data after correction by adding the movement amount stored as the correction amount to each movement amount of the visual data that is read (step S408), and terminates the correction.

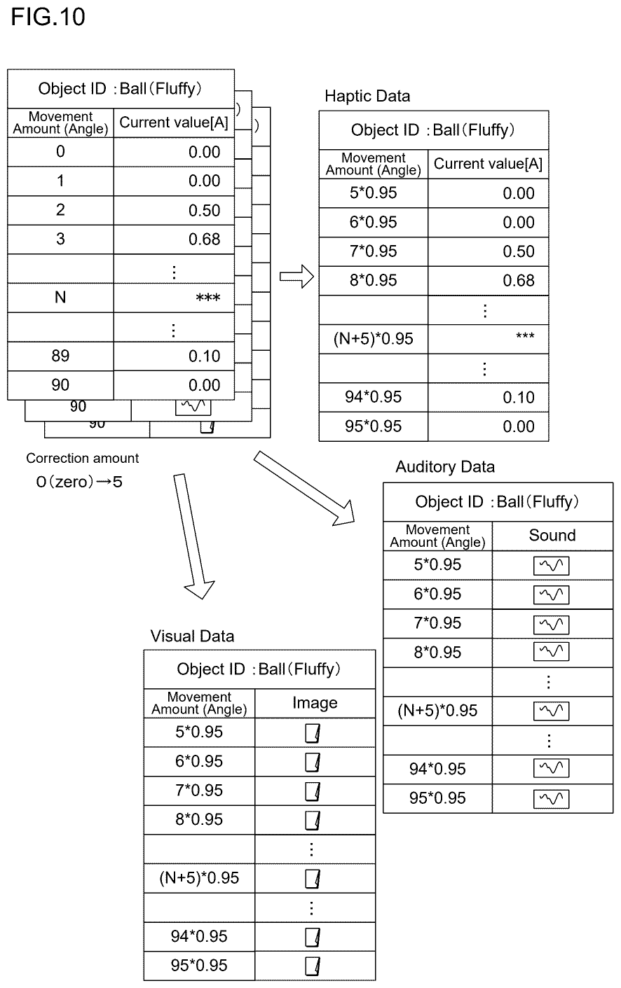

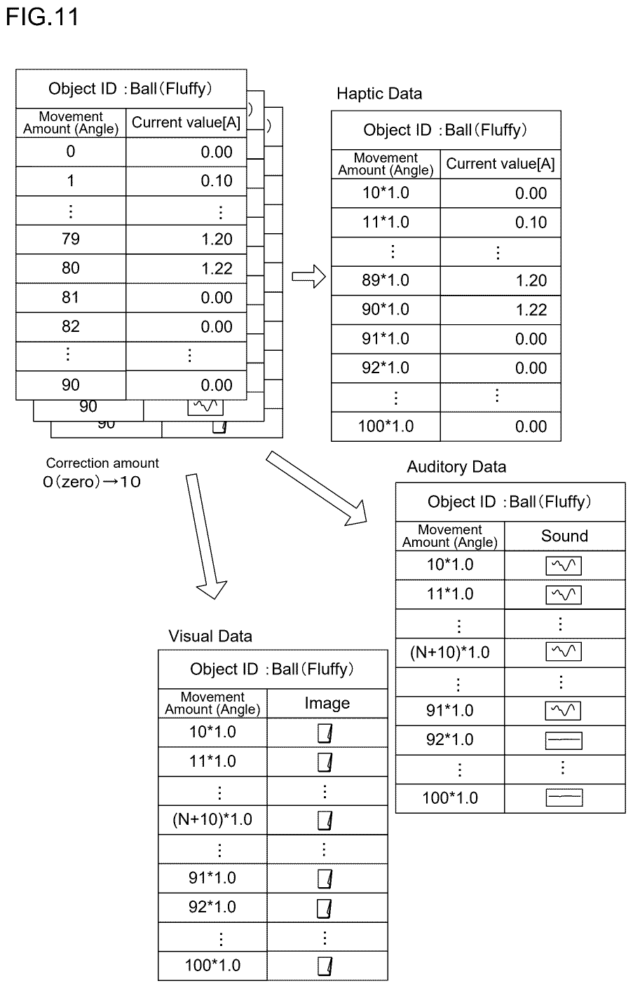

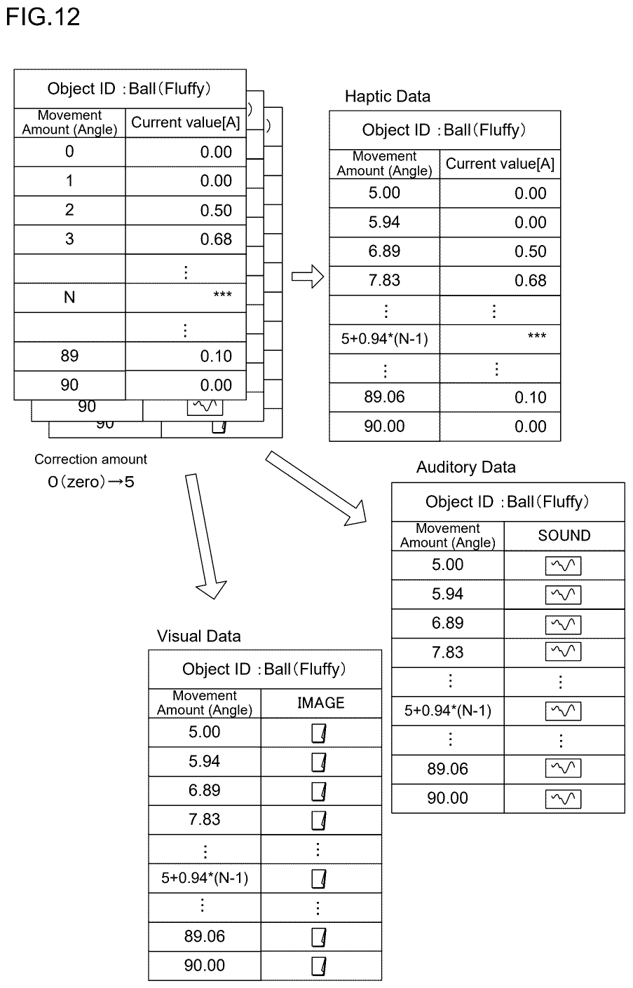

FIGS. 10 to 12 are views illustrating the correction method. FIG. 10 illustrates a method corresponding to the [Method 1], FIG. 11 illustrates a method corresponding to the [Method 2], and FIG. 12 illustrates a method corresponding to the [Method 3].

In the correction method shown in FIG. 10, in a case where the correction amount is set to 5° (degrees), the processing unit 10 calculates a coefficient “0.95” obtained by using the sum “95” of a value “5” of 5° (degrees) and the maximum value “90” of the movement amount as a denominator, and the movable range “90” of the movable part 202 as a numerator. The processing unit 10 multiplies a value (N+5) obtained by adding the correction amount to each movement amount (Nth movement amount corresponding to an integer value of 0 to 90) in the haptic data by the calculated coefficient “0.95”, and allocates the resultant value to the original 91 movement amounts as the correction data.

In the correction method shown in FIG. 11, when a range where a current value in the original haptic data is not zero is 0 to 80° (degrees), (a current value corresponding to 81 to 90° (degrees) is zero), in a case where the correction amount is set to 10° (degrees), the processing unit 10 calculates a coefficient “1.0” by using the sum “90” of a value “10” of 10° (degrees) and the range “80” where the current value is not zero as a denominator, and the movable range “90” of the movable part 202 as a numerator. The processing unit 10 multiplies a value (N+10) obtained by adding the correction amount to each movement amount (Nth movement amount corresponding to an integer value of 1 to 90) in the haptic data by the calculated coefficient “1.0”, and allocates the resultant value to the original 91 movement amounts as the correction data. In this case, a scale of the range where the current value is not zero is changed from 0 to 80° (degrees) to 0 to 90° (degrees).

In the correction method shown in FIG. 12, in a case where the correction amount is set to 5° (degrees), since movement amounts from 5 to 90° (degrees) are allocated to 91 movement amounts (0 to 90° (degrees)), the processing unit 10 calculates a tolerance as (90-5)/(number “91”-1)≈0.944. A numerical value (=initial value+tolerance×(N−1)), which is obtained by multiplying a number obtained by subtracting 1 from Nth N by the tolerance and by adding the number to the initial value, is allocated as an Nth movement amount. This is equivalent to allocating current values corresponding to movement amounts of 0 to 90° (degrees) to movement amounts from the presentation initiation position of 5° (degrees) to the maximum value 90° (degrees), and multiplying the scale, for example, by 1.06 (=1/0.944).

In this way, through the correction, the haptic data, the auditory data, and the visual data become data in which the current value, the auditory data, and the image data are associated with each movement amount after addition of the correction amount as illustrated in FIGS. 10 to 12. That is, correction is made so that a ratio (scale) between the range (movable range) of the movement amount of the movable part 202 and the range of the presented haptic sensation changes.

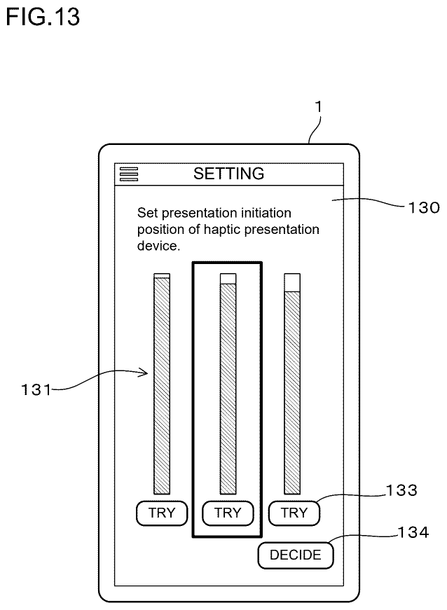

FIG. 13 illustrates another example of the setting screen 130 displayed on the display unit 13. As illustrated in FIG. 8, with regard to the setting screen 130, in a case where a setting menu is selected by the operation unit 15, the processing unit 10 displays the setting screen 130 on the display unit 13. The setting screen 130 displays three different patterns as candidates for the degree of pushing from above at which the haptic presentation begins (haptic presentation position) for the range of the movement amount.

In the example in FIG. 13, the setting screen 130 also includes the test button 133 and the decision button 134. Any can be selected by the decision button 134. In the example shown in FIG. 13, among the three candidates, the central candidate is highlighted with a thick frame (cursor), and it is indicated that the candidate has been selected by tapping by the operation unit 15.

When the test button 133 is selected by an operator, the processing unit 10 detects the selection by the operation unit 15, and determines the movement amount in step S303 by a position of the moved control 132. In a case where the test button 133 is selected, the processing unit 10 executes the processing from step S304 to step S308.

In the example of the setting screen 130 shown in FIG. 13, in a case where the decision button 134 is selected, the processing unit 10 also executes step S308 to step S309.

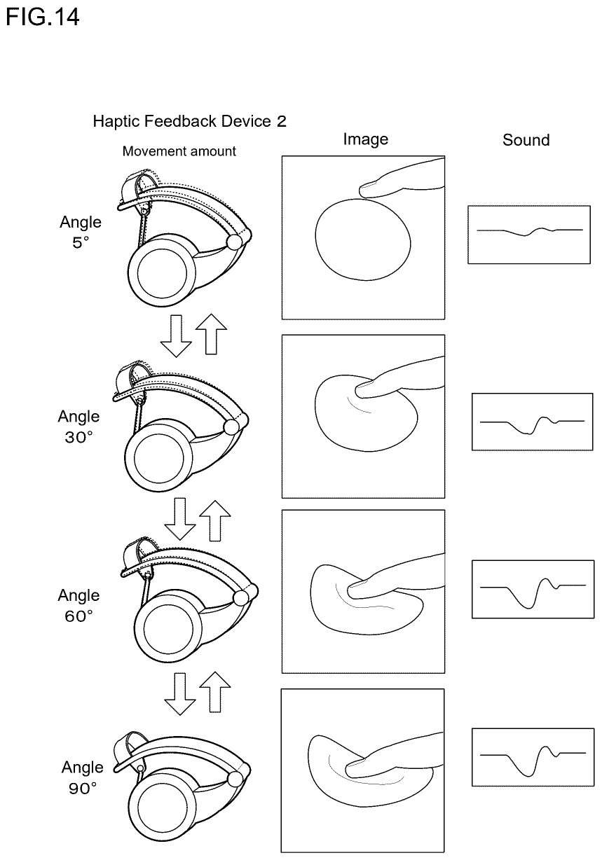

FIG. 14 is a schematic view illustrating an example of haptic presentation in the haptic presentation system 100. In the example shown in FIG. 14, a variation of an image displayed on the display unit 13 and a variation of a sound in correspondence with the movement amount in the haptic data after correction as compared with the example shown in FIG. 6. In FIG. 14, a state in the haptic data before correction is indicated by a broken line. As illustrated in FIG. 14, as compared with FIG. 6, after correction, the haptic sensation starts to be presented from the movable part 202 from a position where the movable part 202 is slightly pushed (corresponding to 5° (degrees)), similarly, the image and the sound are output, and when approaching an upper limit of the movable range of the movable part 202, the presentation position is the same as before the correction.

In this way, it is possible to adjust the haptic presentation initiation position when using the haptic feedback device 2 in conformity to the preference and sensibility of an operator. Since the haptic presentation method in the haptic feedback device 2 conforms to the operator, perceptibility by the operator is improved.

Although description has been given of a configuration in which one correction amount is stored in the information processing device 1, there is no limitation thereto. The correction amount may be stored in the storage unit 11 of one information processing device 1 for every operator, and after accepting selection of an operator who operates the haptic feedback device 2, the processing unit 10 may execute the processing shown in the flowchart of FIG. 5 by using a correction amount that is set.

### Second Embodiment

In a second embodiment, setting of a scale when presenting haptic sensation of an object is directly changed. A configuration of a haptic feedback system 100 according to the second embodiment is the same as the configuration of the haptic feedback system 100 according to the first embodiment except that a scale setting changing method is different. Accordingly, the same reference numeral will be given to a configuration, which is common to the haptic feedback system 100 of the first embodiment, among configurations of the haptic feedback system 100 of the second embodiment, and detailed description thereof will be omitted.

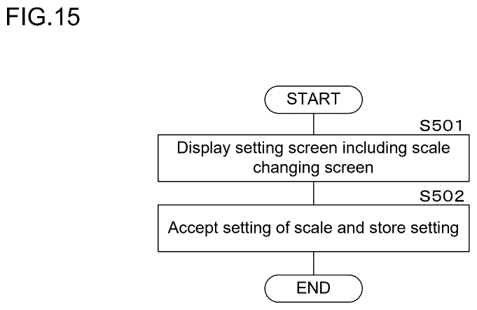

FIG. 15 is a flowchart illustrating an example of a setting method according to the second embodiment. The following procedure may be performed after accepting selection of an object (S102) in the processing shown in the flowchart of FIG. 5, or may be performed simultaneously with presentation initiation position setting acceptance in the first embodiment in a case where the setting menu is selected within the operation screen. Initially, setting of the scale is “1.0”.

The processing unit 10 displays the setting screen including a scale changing screen (step S501). In step S501, the scale changing screen may accept the scale with a numerical value, or may accept change of the initial value “1.0” by performing an operation on a slide bar or an increment/decrement button. A range of the scale may be set so that the scale can be accepted, for example, in a range such as “0.5” to “1.5”.

The processing unit 10 accepts the setting of the scale on the setting screen, stores the setting in the storage unit 11 (step S502), and terminates the processing.

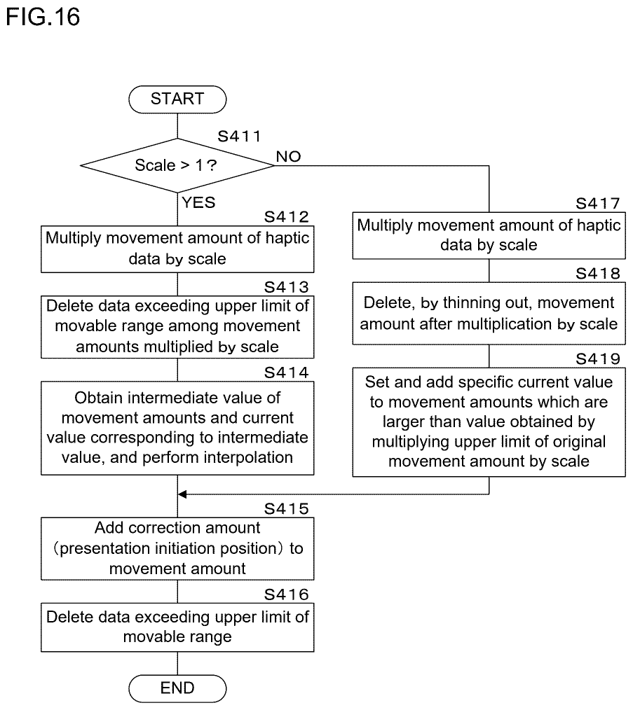

In the second embodiment, the haptic data is corrected by the scale that is set. FIG. 16 is a flowchart illustrating an example of a correction procedure by the scale. The procedure in FIG. 16 corresponds to the procedure performed in step S104 when an information processing device 1 of a third embodiment executes the processing shown in the flowchart of FIG. 6 as in the first embodiment.

The processing unit 10 determines whether or not the scale that is set is larger than 1 (step S411). In a case where it is determined the scale is larger than 1 (S411: YES), the processing unit 10 multiplies the movement amount (0 to 90° (degrees)) of the haptic data read in step S103 by the scale (step S412). According to step S412, for example, in the haptic data before correction, in a case where a movement amount (angle) of 30° (degrees) is associated with a current value of 1.2, a movement amount of 30° (degrees)×(scale>1) is associated with a current value of 1.2. In a case where the scale is 1.2, a movement amount of 36° (degrees) is associated with a current value of 1.2, and in a case where the scale is 1.5, a movement amount of 45° (degrees) is associated with a current value of 1.2.

Since multiplication by the scale is performed in step S412, a step of the movement amount becomes larger than a step of the original movement amount. For example, in a case where the scale is 1.5, the movement amount becomes from (0° (degree), 1° (degree), 2° (degrees), 3° (degrees), . . . , and 90° (degrees)) to (0° (degree), 1.5° (degrees), 3° (degrees), 4.5° (degrees), . . . , and 120° (degrees)). The processing unit 10 deletes data exceeding an upper limit of the movable range among movement amounts multiplied by the scale from haptic data after correction (step S413). That is, the processing unit 10 deletes 91 to 120° (degrees) which are movement amounts after multiplication by the scale (for example, 1.5) and current values corresponding to the movement amounts, and 61 to 90° (degrees) which are original movement amounts and current values corresponding to the movement amounts from the haptic data after correction.

The processing unit 10 obtains an intermediate value of the movement amounts and a current value corresponding to the intermediate value, and performs interpolation (step S414).

In a case where a correction amount corresponding to the presentation initiation position is set, the processing unit 10 adds the correction amount to the movement amount (step S415). The processing unit 10 deletes a corrected movement amount exceeding the upper limit (90° (degrees)) of the movement amount and a current value corresponding to the movement amount from haptic data after correction (step S416), and terminates the processing.

In step S411, it is determined that the scale is smaller than 1 (S411: NO), the processing unit 10 multiplies the movement amounts (0 to 90° (degrees)) of the haptic data that is read in step S103 by the scale, respectively (step S417). According to step S417, for example, in a case where a movement amount (angle) of 30° (degrees) is associated with a current value of 1.2 in the haptic data before correction, a movement amount of 30° (degrees)×(scale<1) is associated with a current value of 1.2. In a case where the scale is 0.8, a movement amount of 24° (degrees) is associated with a current value of 1.2, and in a case where the scale is 0.5, a movement amount of 15° is associated with a current value of 1.2.

Since multiplication by the scale is performed in step S417, a step of the movement amount becomes smaller than a step of the original movement amount. For example, in a case where the scale is 0.5, the movement amount becomes from (0° (degree), 1° (degree), 2° (degrees), 3° (degrees), . . . , and 90° (degrees)) to (0° (degree), 0.5° (degrees), 1° (degree), 1.5° (degrees), . . . , and 45° (degrees)). The processing unit 10 deletes, by thinning out, part of movement amounts after multiplication by the scale, and control data corresponding to the part of the movement amount from the haptic data after correction (step S418). In step S418, in a case where the movement amounts become (0° (degree), 0.5° (degrees), 1° (degree), 1.5° (degrees), . . . , and 45° (degrees)), the processing unit 10 thins out one movement amount per two movement amounts. Haptic data after correction may be created as control data associated with finer movement amounts which are not thinned out.

With respect to movement amounts larger than values obtained by multiplying the upper limit of the original movement amount by the scale, the processing unit 10 sets the current value to 0 (zero) or a current value at which the movable part 202 is not moved, adds the set current value to the haptic data after correction (step S419), and causes the processing to proceed to step S415. In step S419, with respect to movement amounts of 46 to 90° (degrees) larger than the original movement amount of 90° (degrees) after being multiplied by the scale (for example, 0.5), and current values corresponding to the movement amounts, the processing unit 10 adds the current value padded with zero.

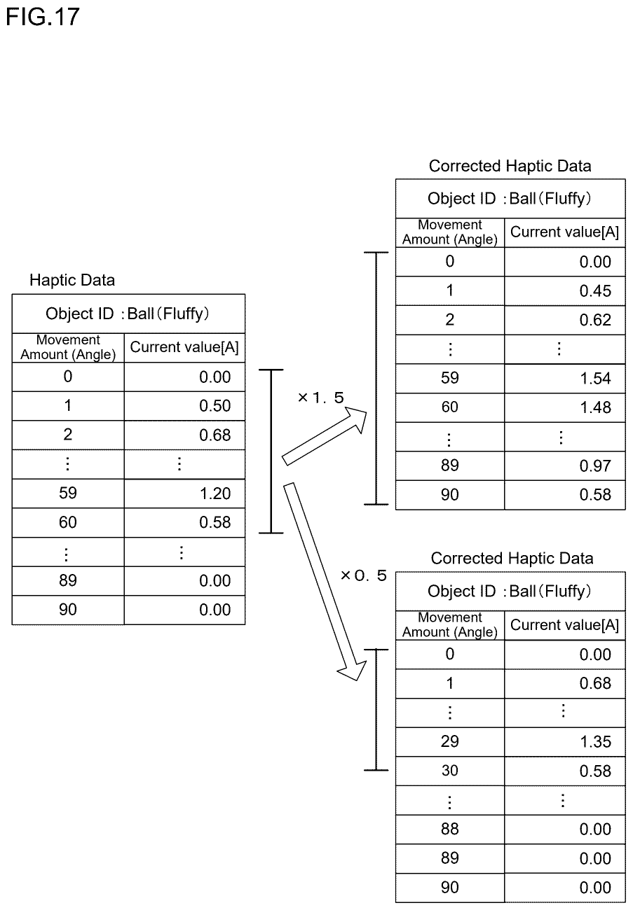

FIG. 17 is a view illustrating a correction method according to the second embodiment. In the example shown in FIG. 17, in the haptic data before correction, a range of the movement amount of 0 to 60° (degrees) is associated with a non-zero current value. In contrast, in a case where the scale is set to 1.5 times, as shown on a right-upper side of FIG. 17, the processing unit 10 creates haptic data after correction by expanding the current values associated with the range of 0 to 60° (degrees) in the original haptic data to a range of 0 to 90° (degrees). In addition, in a case where the scale is set to 0.5 times, as illustrated on a right-lower side in FIG. 17, the processing unit 10 compresses current values associated with the range of 0 to 60° (degrees) in the original haptic data to a range of 0 to 30° (degrees), thins out some of the current values, and creates the haptic data after correction. According to this, it is possible to change the haptic data in correspondence with the scale that is set, and to appropriately present the haptic sensation within the physical movable range of the movable part 202.

Setting of the scale may be automatically changed by the information processing device 1 in correspondence with an image display environment. For example, in correspondence with specifications of the display unit 13, for example, in a case of displaying a tennis ball having a size of 66 mm on the display unit 13 at the half scale of 33 mm in conformity to dimensions on a screen, a correction is made to change the haptic data to an approximately half scale. In this case, the visual data and the auditory data are not changed. In this case, in a case where a movement of the movable part 202 is an angle corresponding to 5 mm, an image recessed by 5 mm in length on the display unit 13 is displayed in synchronization. In a case of superimposing a finger image, the finger image may be superimposed by changing the size of the finger image to a size corresponding to a half scale. For example, in a case where the haptic data corresponds to an actual size and is displayed at a half scale on the display unit 13 of the information processing device 1 such as a smartphone, when the movement of the movable part 202 of the haptic feedback device 2 is an angle corresponding to 5 mm, an image recessed by 2.5 mm (a recession ratio is 7.6% in any case) is displayed on the display unit 13 in synchronization. As described above, in a case where image reduction display is necessary on the display unit 13, the haptic data is corrected in conformity to the scale in the display unit 13, and thus a scale of the haptic sensation and a scale of the visual sensation match each other.

With regard to the auditory data, in a case of using the sound output unit 14 capable of three-dimensionally outputting sound, the scale may correspond to specifications of the display unit 13.

### Third Embodiment

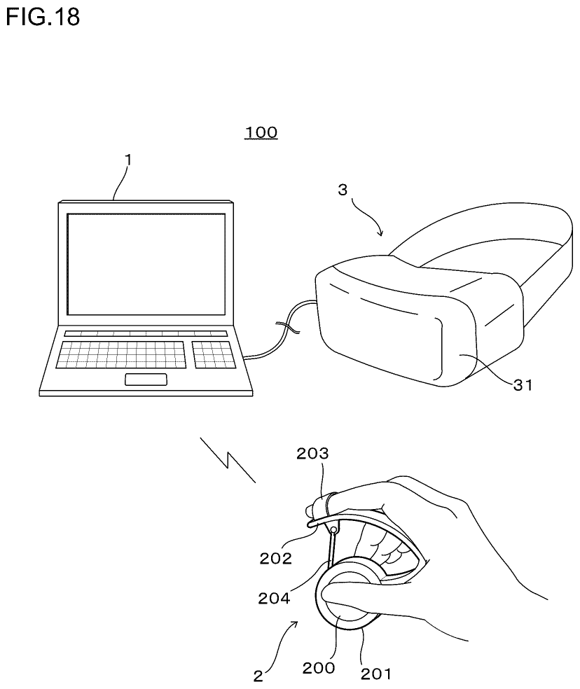

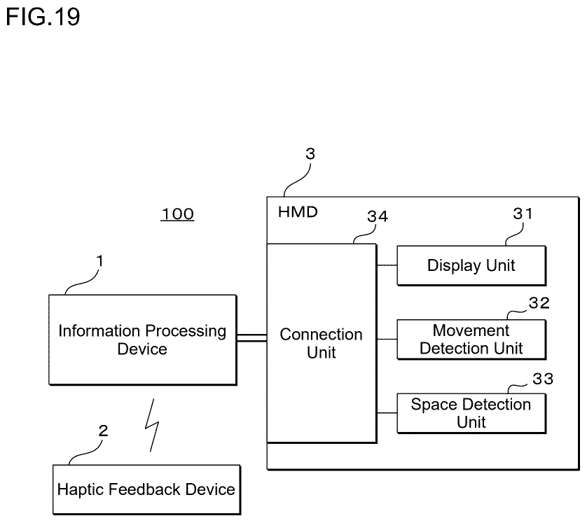

In a third embodiment, visual information of an object is three-dimensionally presented by using a head mounted display (HMD). FIG. 18 is a schematic view of a haptic feedback system 100 according to the third embodiment, and FIG. 19 is a block diagram illustrating a configuration of an HMD 3. The configuration of the haptic feedback system 100 according to the third embodiment has a configuration similar to the configuration of the haptic feedback system 100 according to the first embodiment except that the HMD is used and detailed processing contents due to use of the HMD are different. Accordingly, the same reference numeral will be given to a configuration, which is common to the haptic feedback system 100 of the first embodiment, among configurations of the haptic feedback system 100 of the third embodiment, and detailed description thereof will be omitted.

The HMD 3 includes a display unit 31, a movement detection unit 32, a space detection unit 33, and a connection unit 34. In the HMD 3, the display unit 31, the movement detection unit 32, the space detection unit 33, and the connection unit 34 may be provided in a main body, or some of the units may be provided separately and may transmit and receive a control signal via a communication medium.

For example, the display unit 31 includes a small-sized liquid crystal monitor, an optical lens, and an optical mechanism, and can display a three-dimensional image at a viewing angle of 110° (degrees) or more. The display unit 31 is a transparent or translucent glass-shaped display, receives an image signal (including a video signal) output from the information processing device 1, and displays an image on an actual field of view of an operator in a superimposed manner. The display unit 31 is not limited to the glass shape, and may display an image based on an image signal output from the information processing device 1 in a manner of being superimposed on an image obtained by imaging an actual space with a camera provided to face a forward side.

The movement detection unit 32 includes a plurality of triaxial acceleration sensors and gyro sensors provided in various sites of a main body (a cover and a mounting belt of the display unit 31) in various directions, and a control circuit that outputs collectively outputs signals from the sensor group. A movement of the wearer's head is detected by the movement detection unit 32.

The space detection unit 33 uses two or more infrared cameras arranged in parallel to face an outward side of the main body, and an infrared LED that is provided at an intermediate position of the infrared cameras to emit infrared rays to an outward side. The space detection unit 33 also functions as a depth sensor that measures a distance up to an object existing on an outer side of the main body of the HMD 3. The space detection unit 33 can measure and output a distance from the main body of the HMD 3 to a still object such as a wall and a floor where an operator who wears the HMD 3. Similarly, the space detection unit 33 can measure and output a distance from the main body of the HMD 3 to an arm, a hand, and a finger of the operator.

The connection unit 34 is an interface for connection with the information processing device 1. The HMD 3 outputs signals corresponding to results measured by the movement detection unit 32 and the space detection unit 33 to the information processing device 1, and acquires an image signal output from the information processing device 1 and displays the video signal on the display unit 31.

A speaker may be provided in the HMD 3, and a sound output from the sound output unit 14 of the information processing device 1 may be output from the speaker.

In the haptic presentation system 100 of the third embodiment configured as described above, the information processing device 1 uses the HMD 3, uses a distance to a still object in an actual space measured by the space detection unit 33, and displays a three-dimensional image of a virtual object in a superimposed manner in conformity to an operator's movement detected by the movement detection unit 32 to realize AR display. With regard to selection of an object, with respect to in-image coordinates (coordinates matched with an actual space) of a three-dimensional image of a virtual object displayed on the display unit 31 of the HMD 3, in a case where superimposition of a finger that grips the haptic presentation device 2 can be detected by the space detection unit 33, this is detected as the selection by the processing unit 10 of the information processing device 1.

In addition, also in the third embodiment, the information processing device 1 transmits and receives data of a movement amount and an inclination to and from the haptic presentation device 2, and controls an AR-displayed image and haptic sensation output from the haptic feedback device 2. With regard to processing contents, any processing illustrated in the first embodiment and the second embodiment may be executed.

When AR display using the HMD 3 and the haptic feedback device 2 are combined, an image in which an object is virtually disposed in an actual space may be visually observed by an operator, and haptic sensation of the object can be stored in the haptic feedback device 2. At that time, as described in the first embodiment, the haptic presentation initiation position in the haptic feedback device 2 can be corrected in correspondence with each operator, perceptibility can be further improved.

The embodiments disclosed above are not limitative but illustrative in all respects. The scope of the present invention is defined by the claims and includes all changes falling within the meaning and range equivalent to the claims.

### DESCRIPTION OF REFERENCE NUMERALS

1 information processing device
10 processing unit
11 storage unit
13 display unit
P1 control program
2 haptic feedback device
20 control unit
21 storage unit
202 movable part
24 MRF device

1-7. (canceled)

8. A control device of a haptic feedback device that includes a movable part provided to be moved in response to an operation, generates a sense of force for the operation on the movable part in correspondence with a movement amount of the movable part, and presents haptic sensation of an object to be displayed,
wherein the control device
stores, for each object to be displayed, control data for generating the sense of force in a case where the object is displayed in association with the movement amount of the movable part,
stores, for each object to be displayed, setting data to vary a scale of a range of movement of the movable part in which the sense of force is generated within a movable range of the movable part,
corrects, based on the setting data, a correspondence relationship between the movement amount of the movable part and the control data corresponding to the movement amount, and
outputs the corrected control data associated with the movement amount of the movable part to the haptic feedback device.

9. The control device according to claim 8, wherein the control device
accepts, as the setting data, a movement amount at a start of the range of movement of the movable part in which a sense of force is generated for the movable part, and
changes the scale of the range, based on the accepted movement amount and the movable range of the movable part.

10. The control device according to claim 8, wherein the control device accepts a change of the scale.

11. The control device according to claim 9, wherein the control device
stores the control data in association with the movement amount based on comparison between an actual size of the movable range of the movable part and an actual size of the object, and
corrects, based on the changed scale, the correspondence relationship between the movement amount of the movable part and the control data.

12. A control method of a haptic feedback device that includes a movable part provided to be moved in response to an operation, generates a sense of force for the operation on the movable part in correspondence with a movement amount of the movable part, and presents haptic sensation of an object to be displayed,
the control method comprising causing a computer connected to the haptic feedback device to store, for each object to be displayed, control data for generating the sense of force in a case where the object is displayed in association with the movement amount of the movable part,
store, for each object to be displayed, setting data to vary a scale of a range of movement of the movable part in which the sense of force is generated within a movable range of the movable part,
correct, based on the setting data, a correspondence relationship between the movement amount of the movable part and the control data corresponding to the movement amount, and
output the corrected control data associated with the movement amount of the movable part to the tactile sense presentation device.

13. A haptic feedback system comprising:
a haptic feedback device that includes a movable part provided to be moved in response to an operation, generates a sense of force for the operation on the movable part in correspondence with a movement amount of the movable part, and presents haptic sensation of an object to be displayed; and
an information processing device that is connected to and communicates with the haptic feedback device and includes a display unit,
wherein the information processing device,
stores, for each object to be displayed, control data for generating the sense of force in a case where the object is displayed in association with the movement amount of the movable part, and visual data that is displayed on the display unit,
stores, for each object to be displayed, setting data to vary a scale of a range of movement of the movable part in which the sense of force is generated within a movable range of the movable part,
corrects, based on the setting data, a correspondence relationship between the movement amount of the movable part and the control data corresponding to the movement amount, and
outputs the corrected control data associated with the movement amount of the movable part to the haptic feedback device, and
outputs, based on a visual data after correction, an image to the display unit in correspondence with the movement amount of the movable part.

14. A non-transitory computer readable medium storing a program for haptic feedback control that causes a computer, which is connected to a haptic feedback device that includes a movable part provided to be moved in response to an operation, generates a sense of force for the operation on the movable part in correspondence with a movement amount of the movable part, and presents haptic sensation of an object to be displayed, to execute processing of:
storing, for each object to be displayed, control data for generating the sense of force in a case where the object is displayed in association with the movement amount of the movable part;
storing, for each object to be displayed, setting data to vary a scale of a range of movement of the movable part in which the sense of force is generated within a movable range of the movable part;
correcting, based on the setting data, a correspondence relationship between the movement amount of the movable part and the control data corresponding to the movement amount; and
outputting the corrected control data associated with the movement amount of the movable part to the haptic feedback device.
